(19) United States
(12) Patent Application Publication
(10) Pub. No.: US 2023/0325633 A1
(43) Pub. Date: Oct. 12, 2023

(54) Shuffled Secure Multiparty Deep Learning

(71) Applicant: Micron Technology, Inc., Boise, ID (US)

(72) Inventor: Andre Xian Ming Chang, Bellevue, WA (US)

(21) Appl. No.: 17/715,768

(22) Filed: Apr. 7, 2022

(51) Int. Cl. G06N 3/04; G06F 7/24; G06F 7/50

(52) U.S. Cl. CPC G06N 3/0454; G06F 7/24; G06F 7/50

(57) ABSTRACT

Protection of access to data samples in outsourcing deep learning computations via shuffling parts. For example, each data sample can be configured as the sum of a plurality of randomized parts. Parts from different data samples are shuffled to mix parts from different samples. One or more external entities can be provided with shuffled and randomized parts to generate results of applying a deep learning computation to the parts. The deep learning computation is configured to allow change of the order between applying the summation and applying the deep learning computation. Thus, results of the external entities applying the deep learning computation to their received parts can be shuffled back for the respective data samples for summation. The summation provides the result of applying the deep learning computation to a respective data sample.

### TECHNICAL FIELD

At least some embodiments disclosed herein relate to secured multiparty computing in general and more particularly, but not limited to, computing using accelerators for Artificial Neural Networks (ANNs), such as ANNs configured through machine learning and/or deep learning.

### BACKGROUND

An Artificial Neural Network (ANN) uses a network of neurons to process inputs to the network and to generate outputs from the network.

Deep learning has been applied to many application fields, such as computer vision, speech/audio recognition, natural language processing, machine translation, bioinformatics, drug design, medical image processing, games, etc.

### BRIEF DESCRIPTION OF THE DRAWINGS

The embodiments are illustrated by way of example and not limitation in the figures of the accompanying drawings in which like references indicate similar elements.

FIG. 1 illustrates the distribution of shuffled, randomized data parts from different data samples for outsourced computing according to one embodiment.

FIG. 2 illustrates the reconstruction of computing results for data samples based on computing results from shuffled, randomized data parts according to one embodiment.

FIG. 3 shows a technique to break data samples into parts for shuffled secure multiparty computing using deep learning accelerators according to one embodiment.

FIG. 4 shows an integrated circuit device having a Deep Learning Accelerator and random access memory configured according to one embodiment.

FIG. 5 shows a processing unit configured to perform matrix-matrix operations according to one embodiment.

FIG. 6 shows a processing unit configured to perform matrix-vector operations according to one embodiment.

FIG. 7 shows a processing unit configured to perform vector-vector operations according to one embodiment.

FIG. 8 shows a Deep Learning Accelerator and random access memory configured to autonomously apply inputs to a trained Artificial Neural Network according to one embodiment.

FIG. 9 shows a method of shuffled secure multiparty deep learning computation according to one embodiment.

FIG. 10 shows a block diagram of an example computer system in which embodiments of the present disclosure can operate.

### DETAILED DESCRIPTION

At least some embodiments disclosed herein provide techniques to shuffle data parts of deep learning data samples for data privacy protection in outsource deep learning computations.

Conventional techniques of Secure Multi-Party Computation (SMPC) are based on Homomorphic Encryption. When Homomorphic Encryption is applied, the order of decryption and a computation/operation can be changed/switched without affecting the result. For example, the sum of the ciphertexts of two numbers can be decrypted to obtain the same result of summing the two numbers in clear text. To protect data privacy, a conventional SMPC is configured to provide ciphertexts of data to be operated upon in a computation to external parities in outsourcing the computation (e.g., summation). The results (e.g., sum of the ciphertexts) are decrypted by the data owner to obtain the results of the computation (e.g., addition) as applied to the clear texts.

The encryption key used in Homomorphic Encryption is typically longer than the clear texts of the numbers. As a result, a high precision circuit is required to operate on the ciphertexts in order to handle the ciphertexts that are much longer than the corresponding clear texts in their bit length.

However, typical Deep Learning Accelerators (DLAs) are not configured to with such high precision circuits in performing operations such as multiplication and accumulation of vectors and/or matrices. The lack of high precision circuits (e.g., for multiplication and accumulation operations) can prevent the use of conventional techniques of Secure Multi-Party Computation (SMPC) with such Deep Learning Accelerators (DLAs).

At least some aspects of the present disclosure address the above and other deficiencies by securing data privacy in outsource deep learning computations through shuffling randomized data parts. When the data privacy is protected via shuffling, the use of a long encryption key to create ciphertexts for task outsourcing can be eliminated. As a result, typical Deep Learning Accelerators (DLAs) that do not have high precision circuits (e.g., for acceleration of multiplication and accumulation operations) can also participate in perform the outsourced deep learning computations.

Deep Learning involves evaluating a model against multiple sets of samples. When the data parts from different sample sets are shuffled for distribution to external parties to perform deep learning computations (e.g., performed using DLAs), the external parties cannot recreate the data samples to make sense of the data without obtaining all of the data parts and/or the shuffle key.

Data parts can be created from a data sample via splitting each data element in the data sample such that the sum of the data parts is equal to the data element. The computing tasks assigned to (outsourced to) one or more external parties can be configured such that switching the order of summation and the deep learning computation performed by the external parties does not change the results. Thus, by shuffling the data parts across the samples for distribution to external parties, each of the external parties obtains only a partial, randomized sample. After the data owner receives the computing results back from the external parties, the data owner can shuffle the results back into a correct order for summation to obtain the results of applying the deep learning computation to the samples. As a result, the privacy of the data samples can be protected, while at least a portion of the computation of Deep Learning can be outsourced to external Deep Learning Accelerators that do not have high precision circuits. Such high precision circuits would be required to operate on ciphertexts generated from Homomorphic Encryption if a conventional technique of Secure Multi-Party Computation (SMPC) were to be used.

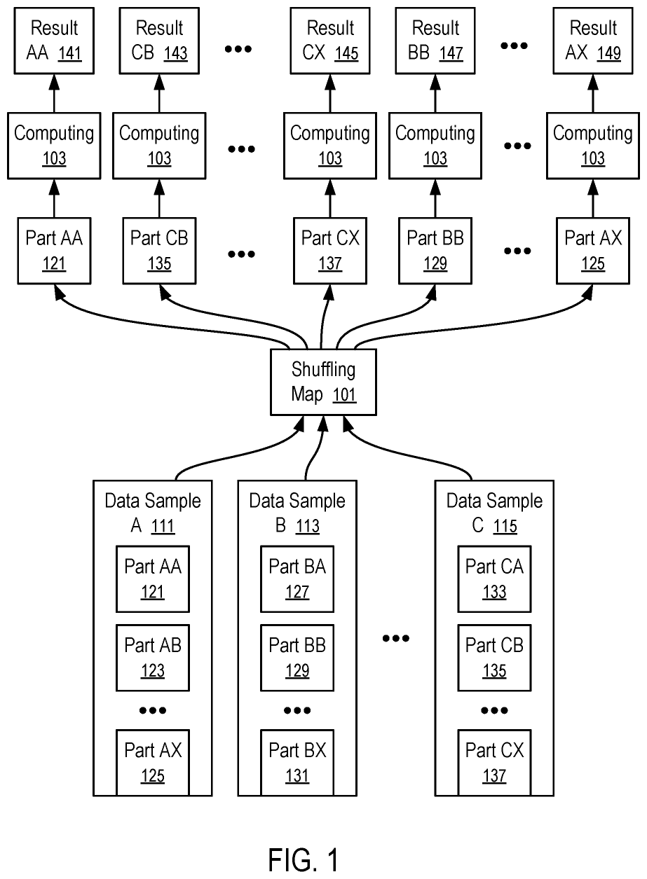

FIG. 1 illustrates the distribution of shuffled, randomized data parts from different data samples for outsourced computing according to one embodiment.

In FIG. 1, it is desirable to obtain the results of applying a same operation of computing 103 to a plurality of data samples 111, 113, . . . , 115. However, it is also desirable to protect the data privacy associated with the data samples 111, 113, . . . , 115 such that the data samples 111, 113, . . . , 115 are not revealed to one or more external entities entrusted to perform the computing 103.

For example, the operation of computing 103 can be configured to be performed using Deep Learning Accelerators; and the data samples 111, 113, . . . , 115 can be sensor data, medical images, or other inputs to an artificial neural network that involves the operation of computing 103.

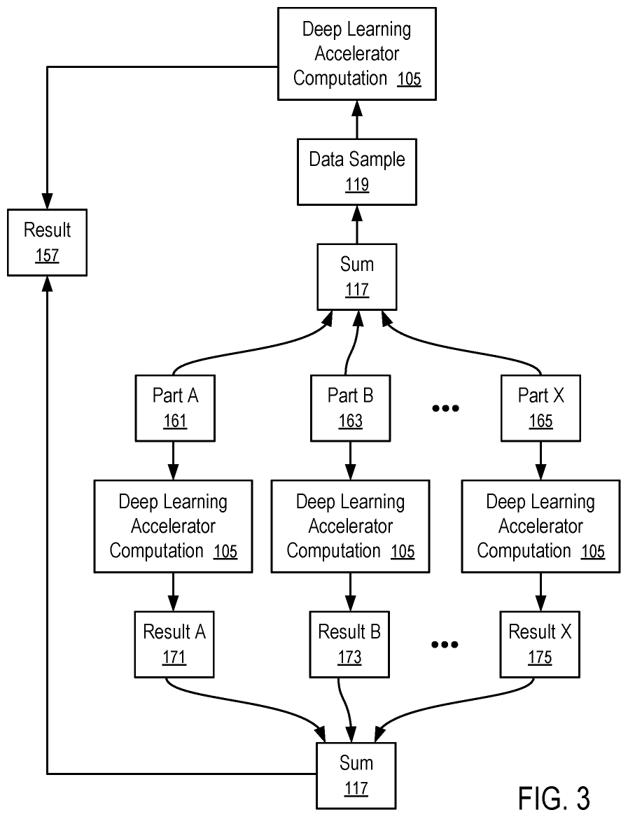

In FIG. 1, each of data samples is split into multiple parts. For example, data sample 111 is divided into randomized parts 121, 123, . . . , 125; data sample 113 is divided into randomized parts 127, 129, . . . , 131; and data sample 115 is divided into randomized parts 133, 135, . . . , 137. For example, the generation of the randomized parts from a data sample can be performed using a technique illustrated in FIG. 3.

A shuffling map 101 is configured to shuffle the parts 121, 123, . . . , 125, 127, 129, . . . , 131, 133, 135, . . . , 137 for the distribution of tasks to apply the operation of computing 103.

For example, the shuffling map 101 can be used to generate a randomized sequence of tasks to apply the operation of computing 103 to the parts 121, 135, . . . , 137, 129, . . . , 125. The operation of computing 103 can be applied to the parts 121, 135, . . . , 137, 129, . . . , 125 to generate respective results 141, 143, . . . , 145, 147, . . . , 149.

Since the parts 121, 135, . . . , 137, 129, . . . , 125 are randomized parts of the data samples 111, 113, . . . , 115 and have been shuffled to mix different parts from different data samples, an external party performing the operation of computing 103 cannot reconstruct the data samples 111, 113, . . . , 115 from the data associated with the computing 103 without the complete sets of parts and the shuffling map 101.

Thus, the operations of the computing 103 can be outsourced for performance by external entities to generate the results 141, 143, . . . , 145, 147, . . . , 149, without revealing the data samples 111, 113, . . . , 115 to the external entities.

In one implementation, the entire set of shuffled parts 121, 135, . . . , 137, 129, . . . , 125 contains all of the parts in the data samples 111, 113, . . . , 115. Optionally, some of the parts in the data samples 111, 113, . . . , 115 are not in the shuffled parts 121, 135, . . . , 137, 129, . . . , 125 communicated to external entities for improved privacy protection. Optionally, the operation of computing 103 applied on parts of the data samples 111, 113, . . . , 115 not in the shuffled parts 121, 135, . . . , 137, 129, . . . , 125 can be outsourced to other external entities and protected using a conventional technique of Secure Multi-Party Computation (SMPC) where the corresponding parts are provided in ciphertexts generated using Homomorphic Encryption. Alternatively, the computation on some of the parts of the data samples 111, 113, . . . , 115 not in the shuffled parts 121, 135, . . . , 137, 129, . . . , 125 can be arranged to be performed by a trusted device, entity or system.

In one implementation, the entire set of shuffled parts 121, 135, . . . , 137, 129, . . . , 125 is distributed to multiple external entities such that each entity does not receive a complete set of parts from a data sample. Optionally, the entire set of shuffled parts 121, 135, . . . , 137, 129, . . . , 125 can be provided to a same external entity to perform the computing 103.

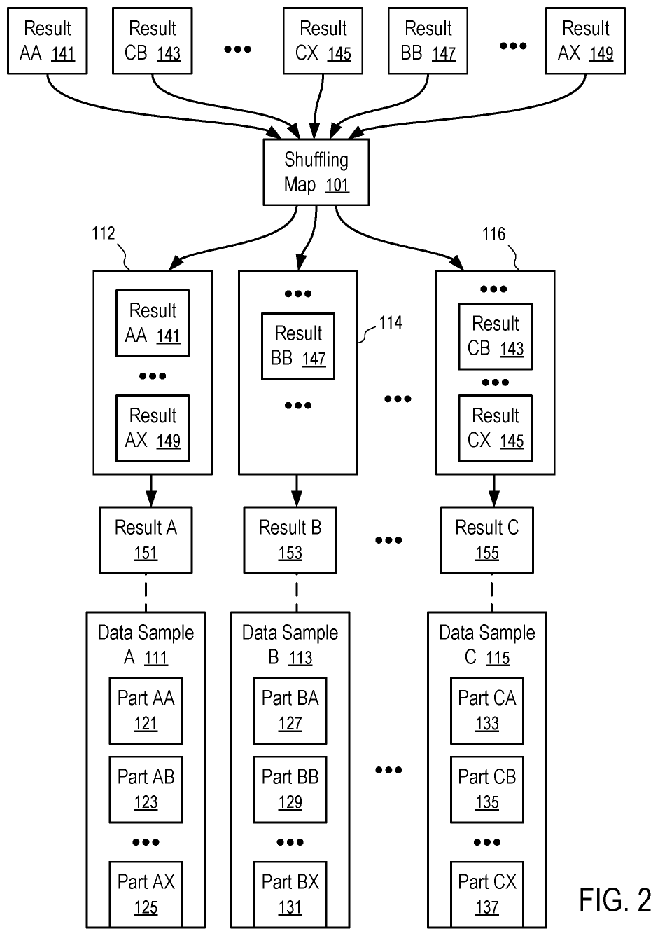

The sequence of results 141, 143, . . . , 145, 147, . . . , 149 corresponding to the shuffled parts 121, 135, . . . , 137, 129, . . . , 125 can be used to construct the results of applying the computing 103 to the data samples 111, 113, . . . , 115 using the shuffling map 101, as illustrated in FIG. 2 and discussed below.

FIG. 2 illustrates the reconstruction of computing results for data samples based on computing results from shuffled, randomized data parts according to one embodiment.

In FIG. 2, the shuffling map 101 is used to sort the results 141, 143, . . . , 145, 147, . . . , 149 into result groups 112, 114, . . . , 116 for the data samples 111, 113, . . . , 115 respectively.

For example, the results 141, . . . , 149 computed for respective parts 121, . . . , 125 of the data sample 111 are sorted according to the shuffling map 101 to the result group 112. Similarly, the results (e.g., 143, . . . , 145) computed for respective parts (e.g., 135, . . . , 137) of the data sample 115 are sorted according to the shuffling map 101 to the result group 116; and the result group 114 contains results (e.g., 147) computed from respective parts (e.g., 129) of the data sample 113.

The results 151, 153, . . . , 155 of applying the operation of computing 103 to the data samples 111, 113, . . . , 115 respectively can be computed from the respective result groups 112, 114, . . . , 116.

For example, when a technique of FIG. 3 is used to generate parts that have a sum equal to a data sample, the results of applying the operation of computing 103 to the parts can be summed to obtain the result of applying the operation of the computing 103 to the data sample.

FIG. 3 shows a technique to break data samples into parts for shuffled secure multiparty computing using deep learning accelerators according to one embodiment.

For example, the technique of FIG. 3 can be used to generate the parts of data samples in FIG. 1, and to generate results of applying the operation of computing 103 to the data samples from results of applying the operation of computing 103 to the parts of the data samples in FIG. 2.

In FIG. 3, a data sample 119 is split into parts 161, 163, . . . , 165, such that the sum 117 of the parts 161, 163, . . . , 165 is equal to the data sample 119.

For example, parts 163, . . . , 165 can be random numbers; and part 161 can be computed from subtracting the data sample 119 from the parts 163, . . . , 165. Thus, the parts 161, 163, . . . , 165 are randomized.

In FIG. 3, a deep learning accelerator computation 105 is configured such that the order of the sum 117 and the computation 105 can be switched without affecting the result 157. Thus, the deep learning accelerator computation 105 as applied to the data sample 119 generates the same result 157 as the sum 117 of the results 171, 173, . . . , 175 obtained from applying the deep learning accelerator computation 105 to the parts 161, 163, . . . , 165 respectively.

For example, the data sample 119 can be a vector or a matrix/tensor representative of an input to an artificial neural network. When the deep learning accelerator computation 105 is configured to apply a linear operation to the data sample 119 (e.g., an operation representative of the processing by the artificial neural network), the result 157 is same as the sum of the results 171, 173, . . . , 175 from the computation 105 being applied to the parts 161, 163, . . . , 165 respectively. For example, a matrix or tensor can be generated according to the neuron connectivity in the artificial neural network and the weights of the artificial neurons applied to their inputs to generate outputs; the deep learning accelerator computation 105 can be the multiplication of the matrix or tensor with the input vector or matrix/tensor of the data sample 119 as the input to the artificial neural network to obtain the output of the artificial neural network; and such a computation 105 is a linear operation applied to the data sample 119. While the parts 161, 163, . . . , 165 appear to be random, the data sample 119 and the result 157 can contain sensitive information that needs protection.

In FIG. 1, when a shuffling map 101 is used to mix parts from different data samples 111, 113, . . . , 115, the difficulty to discover the original data samples 111, 113, . . . , 115 is increased.

The technique of shuffling parts can eliminate or reduce the use of a traditional technique of Secure Multi-Party Computation (SMPC) that requires deep learning accelerators having high precision computing units to operate on ciphertexts generated using a long encryption key.

A data item (e.g., a number) in a data sample 119 is typically specified at a predetermined precision level (e.g., represented by a predetermined number of bits) for computation by a deep learning accelerator. When the data sample 119 is split into parts 161, 163, . . . , 165, the parts can be in the same level of precision (e.g., represented by bits of the predetermined number). Thus, the operation of splitting the data sample 119 into parts 161, 163, . . . , 165 and the operation of shuffling the parts of different data samples (e.g., 111, 113, . . . , 115) do not change or increase the precision level of data items involved in the computation.

In contrast, when a traditional technique of Secure Multi-Party Computation (SMPC) is used, a data items (e.g., a number) is combined with a long encryption key to generate a ciphertext. A long encryption key is used for security. As a result, the ciphertext has an increased precision level (e.g., represented by an increased number of bits). To apply the deep learning accelerator computation 105 on the ciphertext having an increased precision level, the deep learning accelerator is required to have a computing circuit (e.g., a multiply-accumulate (MAC) unit) at the corresponding increased precision level. The technique of protecting data privacy through shuffling across data samples can remove the requirement of encryption using a long encryption key. As a result, deep learning accelerators without high precision computing circuits as required by the used of the long encryption key can also be used in Secure Multi-Party Computation (SMPC).

For example, a deep learning accelerator can be configured to perform multiply-accumulate (MAC) operations at a first level of precision (e.g., 16-bit, 32-bit, 64-bit, etc.). Such a precision can be sufficient for the computations of an Artificial Neural Network (ANN). However, when the use of Homomorphic Encryption increases the precision requirement to a second level (e.g., 128-bit, 512-bit, etc.), the deep learning accelerator cannot be used to perform the computation on ciphertexts generated using the Homomorphic Encryption. The use of the shuffling map 101 to protect the data privacy allows such a deep learning accelerator to perform outsourced computation (e.g., 105).

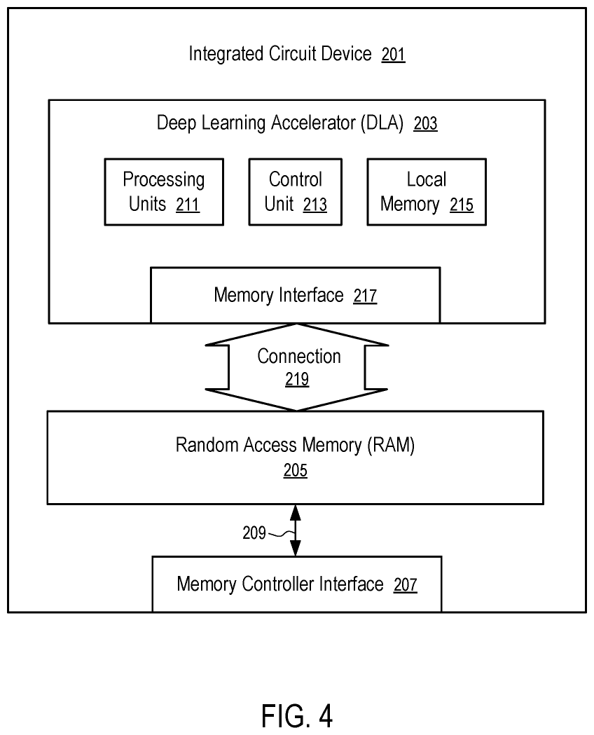

For example, the task of applying the operation of computing 103 to a part 121 can be outsourced to a computing device having an integrated circuit device include a Deep Learning Accelerator (DLA) and random access memory (e.g., as illustrated in FIG. 4). The random access memory can be configured to store parameters representative of an Artificial Neural Network (ANN) and instructions having matrix operands representative of a deep learning accelerator computation 105. The instructions stored in the random access memory can be executable by the Deep Learning Accelerator (DLA) to implement matrix computations according to the Artificial Neural Network (ANN), as further discussed below.

In a typical configuration, each neuron in an Artificial Neural Network (ANN) receives a set of inputs. Some of the inputs to a neuron may be the outputs of certain neurons in the network; and some of the inputs to a neuron may be the inputs provided to the neural network. The input/output relations among the neurons in the network represent the neuron connectivity in the network. Each neuron can have a bias, an activation function, and a set of synaptic weights for its inputs respectively. The activation function may be in the form of a step function, a linear function, a log-sigmoid function, etc. Different neurons in the network may have different activation functions. Each neuron can generate a weighted sum of its inputs and its bias and then produce an output that is the function of the weighted sum, computed using the activation function of the neuron. The relations between the input(s) and the output(s) of an ANN in general are defined by an ANN model that includes the data representing the connectivity of the neurons in the network, as well as the bias, activation function, and synaptic weights of each neuron. Based on a given ANN model, a computing device can be configured to compute the output(s) of the network from a given set of inputs to the network.

Since the outputs of the Artificial Neural Network (ANN) can be a linear operation on the inputs to the artificial neurons, data samples (e.g., 119) representative of an input to the Artificial Neural Network (ANN) can be split into parts (e.g., 161, 163, . . . , 165 as in FIG. 3) as randomized inputs to the Artificial Neural Network (ANN) such that the sum of the outputs responsive to the randomized inputs provides the correct outputs of the Artificial Neural Network (ANN) responding to the data samples (e.g., 119).

In some instances, the relation between the inputs and outputs of an entire Artificial Neural Network (ANN) is not a linear operation that supports the computation of the result 157 for a data sample 119 from the sum 117 of the results 171, 173, . . . , 175 obtained from the parts 161, 163, . . . , 165. However, a significant portion of the computation of the Artificial Neural Network (ANN) can be a task that involves a linear operation. Such a portion can be accelerated with the use of deep learning accelerators (e.g., as in FIG. 4). Thus, the shuffling of parts allows the outsourcing of such a portion of computation to multiple external computing devices having deep learning accelerators.

A Deep Learning Accelerator can have local memory, such as registers, buffers and/or caches, configured to store vector/matrix operands and the results of vector/matrix operations. Intermediate results in the registers can be pipelined/shifted in the Deep Learning Accelerator as operands for subsequent vector/matrix operations to reduce time and energy consumption in accessing memory/data and thus speed up typical patterns of vector/matrix operations in implementing a typical Artificial Neural Network. The capacity of registers, buffers and/or caches in the Deep Learning Accelerator is typically insufficient to hold the entire data set for implementing the computation of a typical Artificial Neural Network. Thus, a random access memory coupled to the Deep Learning Accelerator is configured to provide an improved data storage capability for implementing a typical Artificial Neural Network. For example, the Deep Learning Accelerator loads data and instructions from the random access memory and stores results back into the random access memory.

The communication bandwidth between the Deep Learning Accelerator and the random access memory is configured to optimize or maximize the utilization of the computation power of the Deep Learning Accelerator. For example, high communication bandwidth can be provided between the Deep Learning Accelerator and the random access memory such that vector/matrix operands can be loaded from the random access memory into the Deep Learning Accelerator and results stored back into the random access memory in a time period that is approximately equal to the time for the Deep Learning Accelerator to perform the computations on the vector/matrix operands. The granularity of the Deep Learning Accelerator can be configured to increase the ratio between the amount of computations performed by the Deep Learning Accelerator and the size of the vector/matrix operands such that the data access traffic between the Deep Learning Accelerator and the random access memory can be reduced, which can reduce the requirement on the communication bandwidth between the Deep Learning Accelerator and the random access memory. Thus, the bottleneck in data/memory access can be reduced or eliminated.

FIG. 4 shows an integrated circuit device 201 having a Deep Learning Accelerator 203 and random access memory 205 configured according to one embodiment.

For example, a computing device having an integrated circuit device 201 can be used to perform the outsourced computing 103 in FIG. 1 and the deep learning accelerator computation 105 of FIG. 3.

The Deep Learning Accelerator 203 in FIG. 4 includes processing units 211, a control unit 213, and local memory 215. When vector and matrix operands are in the local memory 215, the control unit 213 can use the processing units 211 to perform vector and matrix operations in accordance with instructions. Further, the control unit 213 can load instructions and operands from the random access memory 205 through a memory interface 217 and a high speed/bandwidth connection 219.

The integrated circuit device 201 is configured to be enclosed within an integrated circuit package with pins or contacts for a memory controller interface 207.

The memory controller interface 207 is configured to support a standard memory access protocol such that the integrated circuit device 201 appears to a typical memory controller in a way same as a conventional random access memory device having no Deep Learning Accelerator 203. For example, a memory controller external to the integrated circuit device 201 can access, using a standard memory access protocol through the memory controller interface 207, the random access memory 205 in the integrated circuit device 201.

The integrated circuit device 201 is configured with a high bandwidth connection 219 between the random access memory 205 and the Deep Learning Accelerator 203 that are enclosed within the integrated circuit device 201. The bandwidth of the connection 219 is higher than the bandwidth of the connection 209 between the random access memory 205 and the memory controller interface 207.

In one embodiment, both the memory controller interface 207 and the memory interface 217 are configured to access the random access memory 205 via a same set of buses or wires. Thus, the bandwidth to access the random access memory 205 is shared between the memory interface 217 and the memory controller interface 207. Alternatively, the memory controller interface 207 and the memory interface 217 are configured to access the random access memory 205 via separate sets of buses or wires. Optionally, the random access memory 205 can include multiple sections that can be accessed concurrently via the connection 219. For example, when the memory interface 217 is accessing a section of the random access memory 205, the memory controller interface 207 can concurrently access another section of the random access memory 205. For example, the different sections can be configured on different integrated circuit dies and/or different planes/banks of memory cells; and the different sections can be accessed in parallel to increase throughput in accessing the random access memory 205. For example, the memory controller interface 207 is configured to access one data unit of a predetermined size at a time; and the memory interface 217 is configured to access multiple data units, each of the same predetermined size, at a time.

In one embodiment, the random access memory 205 and the integrated circuit device 201 are configured on different integrated circuit dies configured within a same integrated circuit package. Further, the random access memory 205 can be configured on one or more integrated circuit dies that allows parallel access of multiple data elements concurrently.

In some implementations, the number of data elements of a vector or matrix that can be accessed in parallel over the connection 219 corresponds to the granularity of the Deep Learning Accelerator operating on vectors or matrices. For example, when the processing units 211 can operate on a number of vector/matrix elements in parallel, the connection 219 is configured to load or store the same number, or multiples of the number, of elements via the connection 219 in parallel.

Optionally, the data access speed of the connection 219 can be configured based on the processing speed of the Deep Learning Accelerator 203. For example, after an amount of data and instructions have been loaded into the local memory 215, the control unit 213 can execute an instruction to operate on the data using the processing units 211 to generate output. Within the time period of processing to generate the output, the access bandwidth of the connection 219 allows the same amount of data and instructions to be loaded into the local memory 215 for the next operation and the same amount of output to be stored back to the random access memory 205. For example, while the control unit 213 is using a portion of the local memory 215 to process data and generate output, the memory interface 217 can offload the output of a prior operation into the random access memory 205 from, and load operand data and instructions into, another portion of the local memory 215. Thus, the utilization and performance of the Deep Learning Accelerator are not restricted or reduced by the bandwidth of the connection 219.

The random access memory 205 can be used to store the model data of an Artificial Neural Network and to buffer input data for the Artificial Neural Network. The model data does not change frequently. The model data can include the output generated by a compiler for the Deep Learning Accelerator to implement the Artificial Neural Network. The model data typically includes matrices used in the description of the Artificial Neural Network and instructions generated for the Deep Learning Accelerator 203 to perform vector/matrix operations of the Artificial Neural Network based on vector/matrix operations of the granularity of the Deep Learning Accelerator 203. The instructions operate not only on the vector/matrix operations of the Artificial Neural Network, but also on the input data for the Artificial Neural Network.

In one embodiment, when the input data is loaded or updated in the random access memory 205, the control unit 213 of the Deep Learning Accelerator 203 can automatically execute the instructions for the Artificial Neural Network to generate an output of the Artificial Neural Network. The output is stored into a predefined region in the random access memory 205. The Deep Learning Accelerator 203 can execute the instructions without help from a Central Processing Unit (CPU). Thus, communications for the coordination between the Deep Learning Accelerator 203 and a processor outside of the integrated circuit device 201 (e.g., a Central Processing Unit (CPU)) can be reduced or eliminated.

Optionally, the logic circuit of the Deep Learning Accelerator 203 can be implemented via Complementary Metal Oxide Semiconductor (CMOS). For example, the technique of CMOS Under the Array (CUA) of memory cells of the random access memory 205 can be used to implement the logic circuit of the Deep Learning Accelerator 203, including the processing units 211 and the control unit 213. Alternatively, the technique of CMOS in the Array of memory cells of the random access memory 205 can be used to implement the logic circuit of the Deep Learning Accelerator 203.

In some implementations, the Deep Learning Accelerator 203 and the random access memory 205 can be implemented on separate integrated circuit dies and connected using Through-Silicon Vias (TSV) for increased data bandwidth between the Deep Learning Accelerator 203 and the random access memory 205. For example, the Deep Learning Accelerator 203 can be formed on an integrated circuit die of a Field-Programmable Gate Array (FPGA) or Application Specific Integrated circuit (ASIC).

Alternatively, the Deep Learning Accelerator 203 and the random access memory 205 can be configured in separate integrated circuit packages and connected via multiple point-to-point connections on a printed circuit board (PCB) for parallel communications and thus increased data transfer bandwidth.

The random access memory 205 can be volatile memory or non-volatile memory, or a combination of volatile memory and non-volatile memory. Examples of non-volatile memory include flash memory, memory cells formed based on negative-and (NAND) logic gates, negative-or (NOR) logic gates, Phase-Change Memory (PCM), magnetic memory (MRAM), resistive random-access memory, cross point storage and memory devices. A cross point memory device can use transistor-less memory elements, each of which has a memory cell and a selector that are stacked together as a column. Memory element columns are connected via two lays of wires running in perpendicular directions, where wires of one lay run in one direction in the layer that is located above the memory element columns, and wires of the other lay run in another direction and are located below the memory element columns. Each memory element can be individually selected at a cross point of one wire on each of the two layers. Cross point memory devices are fast and non-volatile and can be used as a unified memory pool for processing and storage. Further examples of non-volatile memory include Read-Only Memory (ROM), Programmable Read-Only Memory (PROM), Erasable Programmable Read-Only Memory (EPROM) and Electronically Erasable Programmable Read-Only Memory (EEPROM) memory, etc. Examples of volatile memory include Dynamic Random-Access Memory (DRAM) and Static Random-Access Memory (SRAM).

For example, non-volatile memory can be configured to implement at least a portion of the random access memory 205. The non-volatile memory in the random access memory 205 can be used to store the model data of an Artificial Neural Network. Thus, after the integrated circuit device 201 is powered off and restarts, it is not necessary to reload the model data of the Artificial Neural Network into the integrated circuit device 201. Further, the non-volatile memory can be programmable/rewritable. Thus, the model data of the Artificial Neural Network in the integrated circuit device 201 can be updated or replaced to implement an update Artificial Neural Network, or another Artificial Neural Network.

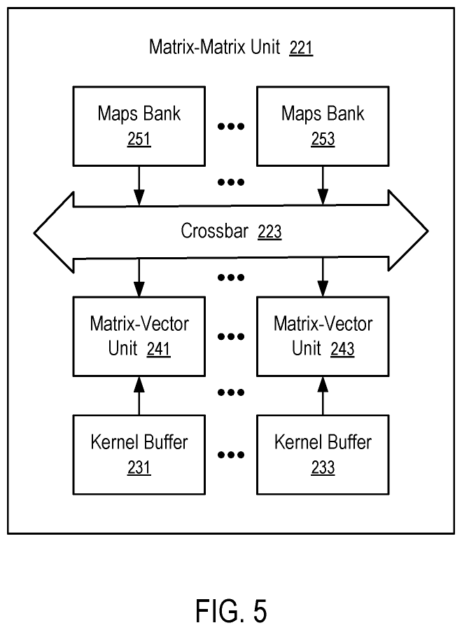

The processing units 211 of the Deep Learning Accelerator 203 can include vector-vector units, matrix-vector units, and/or matrix-matrix units. Examples of units configured to perform for vector-vector operations, matrix-vector operations, and matrix-matrix operations are discussed below in connection with FIGS. 5-7.

FIG. 5 shows a processing unit configured to perform matrix-matrix operations according to one embodiment. For example, the matrix-matrix unit 221 of FIG. 5 can be used as one of the processing units 211 of the Deep Learning Accelerator 203 of FIG. 4.

In FIG. 5, the matrix-matrix unit 221 includes multiple kernel buffers 231 to 233 and multiple the maps banks 251 to 253. Each of the maps banks 251 to 253 stores one vector of a matrix operand that has multiple vectors stored in the maps banks 251 to 253 respectively; and each of the kernel buffers 231 to 233 stores one vector of another matrix operand that has multiple vectors stored in the kernel buffers 231 to 233 respectively. The matrix-matrix unit 221 is configured to perform multiplication and accumulation operations on the elements of the two matrix operands, using multiple matrix-vector units 241 to 243 that operate in parallel.

A crossbar 223 connects the maps banks 251 to 253 to the matrix-vector units 241 to 243. The same matrix operand stored in the maps bank 251 to 253 is provided via the crossbar 223 to each of the matrix-vector units 241 to 243; and the matrix-vector units 241 to 243 receives data elements from the maps banks 251 to 253 in parallel. Each of the kernel buffers 231 to 233 is connected to a respective one in the matrix-vector units 241 to 243 and provides a vector operand to the respective matrix-vector unit. The matrix-vector units 241 to 243 operate concurrently to compute the operation of the same matrix operand, stored in the maps banks 251 to 253 multiplied by the corresponding vectors stored in the kernel buffers 231 to 233. For example, the matrix-vector unit 241 performs the multiplication operation on the matrix operand stored in the maps banks 251 to 253 and the vector operand stored in the kernel buffer 231, while the matrix-vector unit 243 is concurrently performing the multiplication operation on the matrix operand stored in the maps banks 251 to 253 and the vector operand stored in the kernel buffer 233.

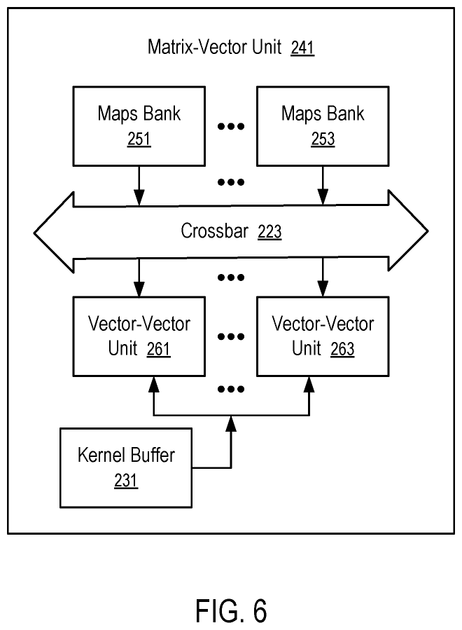

Each of the matrix-vector units 241 to 243 in FIG. 5 can be implemented in a way as illustrated in FIG. 6.

FIG. 6 shows a processing unit configured to perform matrix-vector operations according to one embodiment. For example, the matrix-vector unit 241 of FIG. 6 can be used as any of the matrix-vector units in the matrix-matrix unit 221 of FIG. 5.

In FIG. 6, each of the maps banks 251 to 253 stores one vector of a matrix operand that has multiple vectors stored in the maps banks 251 to 253 respectively, in a way similar to the maps banks 251 to 253 of FIG. 5. The crossbar 223 in FIG. 6 provides the vectors from the maps banks 251 to the vector-vector units 261 to 263 respectively. A same vector stored in the kernel buffer 231 is provided to the vector-vector units 261 to 263.

The vector-vector units 261 to 263 operate concurrently to compute the operation of the corresponding vector operands, stored in the maps banks 251 to 253 respectively, multiplied by the same vector operand that is stored in the kernel buffer 231. For example, the vector-vector unit 261 performs the multiplication operation on the vector operand stored in the maps bank 251 and the vector operand stored in the kernel buffer 231, while the vector-vector unit 263 is concurrently performing the multiplication operation on the vector operand stored in the maps bank 253 and the vector operand stored in the kernel buffer 231.

When the matrix-vector unit 241 of FIG. 6 is implemented in a matrix-matrix unit 221 of FIG. 5, the matrix-vector unit 241 can use the maps banks 251 to 253, the crossbar 223 and the kernel buffer 231 of the matrix-matrix unit 221.

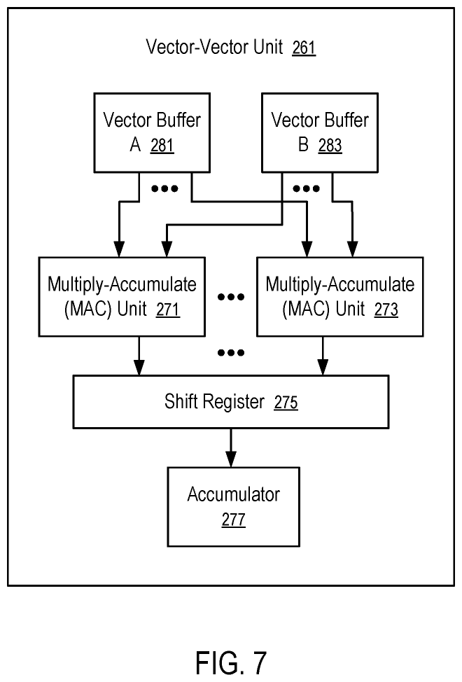

Each of the vector-vector units 261 to 263 in FIG. 6 can be implemented in a way as illustrated in FIG. 7.

FIG. 7 shows a processing unit configured to perform vector-vector operations according to one embodiment. For example, the vector-vector unit 261 of FIG. 7 can be used as any of the vector-vector units in the matrix-vector unit 241 of FIG. 6.

In FIG. 7, the vector-vector unit 261 has multiple multiply-accumulate (MAC) units 271 to 273. Each of the multiply-accumulate (MAC) units (e.g., 273) can receive two numbers as operands, perform multiplication of the two numbers, and add the result of the multiplication to a sum maintained in the multiply-accumulate unit.

Each of the vector buffers 281 and 283 stores a list of numbers. A pair of numbers, each from one of the vector buffers 281 and 283, can be provided to each of the multiply-accumulate (MAC) units 271 to 273 as input. The multiply-accumulate (MAC) units 271 to 273 can receive multiple pairs of numbers from the vector buffers 281 and 283 in parallel and perform the multiply-accumulate (MAC) operations in parallel. The outputs from the multiply-accumulate (MAC) units 271 to 273 are stored into the shift register 275; and an accumulator 277 computes the sum of the results in the shift register 275.

When the vector-vector unit 261 of FIG. 7 is implemented in a matrix-vector unit 241 of FIG. 6, the vector-vector unit 261 can use a maps bank (e.g., 251 or 253) as one vector buffer 281, and the kernel buffer 231 of the matrix-vector unit 241 as another vector buffer 283.

The vector buffers 281 and 283 can have a same length to store the same number/count of data elements. The length can be equal to, or the multiple of, the count of multiply-accumulate (MAC) units 271 to 273 in the vector-vector unit 261. When the length of the vector buffers 281 and 283 is the multiple of the count of multiply-accumulate (MAC) units 271 to 273, a number of pairs of inputs, equal to the count of the multiply-accumulate (MAC) units 271 to 273, can be provided from the vector buffers 281 and 283 as inputs to the multiply-accumulate (MAC) units 271 to 273 in each iteration; and the vector buffers 281 and 283 feed their elements into the multiply-accumulate (MAC) units 271 to 273 through multiple iterations.

In one embodiment, the communication bandwidth of the connection 219 between the Deep Learning Accelerator 203 and the random access memory 205 is sufficient for the matrix-matrix unit 221 to use portions of the random access memory 205 as the maps banks 251 to 253 and the kernel buffers 231 to 233.

In another embodiment, the maps banks 251 to 253 and the kernel buffers 231 to 233 are implemented in a portion of the local memory 215 of the Deep Learning Accelerator 203. The communication bandwidth of the connection 219 between the Deep Learning Accelerator 203 and the random access memory 205 is sufficient to load, into another portion of the local memory 215, matrix operands of the next operation cycle of the matrix-matrix unit 221, while the matrix-matrix unit 221 is performing the computation in the current operation cycle using the maps banks 251 to 253 and the kernel buffers 231 to 233 implemented in a different portion of the local memory 215 of the Deep Learning Accelerator 203.

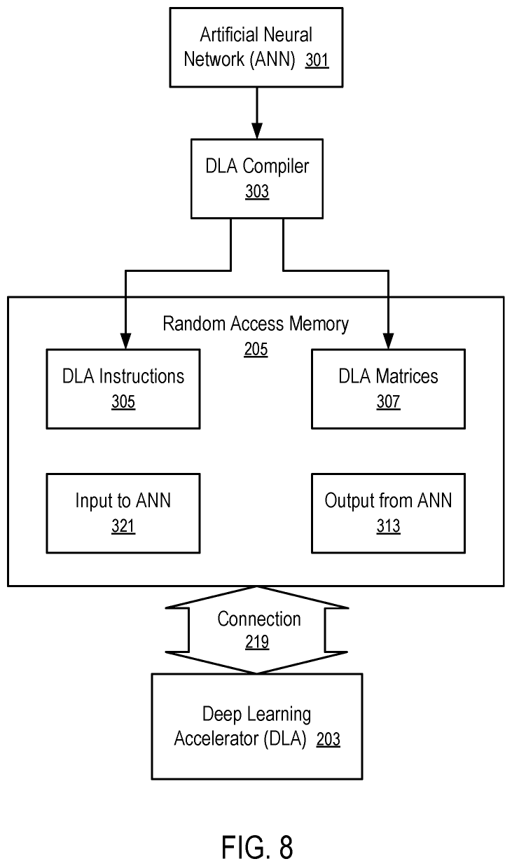

FIG. 8 shows a Deep Learning Accelerator and random access memory configured to autonomously apply inputs to a trained Artificial Neural Network according to one embodiment.

An Artificial Neural Network 301 that has been trained through machine learning (e.g., deep learning) can be described in a standard format (e.g., Open Neural Network Exchange (ONNX)). The description of the trained Artificial Neural Network 301 in the standard format identifies the properties of the artificial neurons and their connectivity.

In FIG. 8, a Deep Learning Accelerator compiler 303 converts trained Artificial Neural Network 301 by generating instructions 305 for a Deep Learning Accelerator 203 and matrices 307 corresponding to the properties of the artificial neurons and their connectivity. The instructions 305 and the matrices 307 generated by the DLA compiler 303 from the trained Artificial Neural Network 301 can be stored in random access memory 205 for the Deep Learning Accelerator 203.

For example, the random access memory 205 and the Deep Learning Accelerator 203 can be connected via a high bandwidth connection 219 in a way as in the integrated circuit device 201 of FIG. 4. The autonomous computation of FIG. 8 based on the instructions 305 and the matrices 307 can be implemented in the integrated circuit device 201 of FIG. 4. Alternatively, the random access memory 205 and the Deep Learning Accelerator 203 can be configured on a printed circuit board with multiple point to point serial buses running in parallel to implement the connection 219.

In FIG. 8, after the results of the DLA compiler 303 are stored in the random access memory 205, the application of the trained Artificial Neural Network 301 to process an input 321 to the trained Artificial Neural Network 301 to generate the corresponding output 313 of the trained Artificial Neural Network 301 can be triggered by the presence of the input 321 in the random access memory 205, or another indication provided in the random access memory 205.

In response, the Deep Learning Accelerator 203 executes the instructions 305 to combine the input 321 and the matrices 307. The matrices 307 can include kernel matrices to be loaded into kernel buffers 231 to 233 and maps matrices to be loaded into maps banks 251 to 253. The execution of the instructions 305 can include the generation of maps matrices for the maps banks 251 to 253 of one or more matrix-matrix units (e.g., 221) of the Deep Learning Accelerator 203.

In some embodiments, the inputs to Artificial Neural Network 301 is in the form of an initial maps matrix. Portions of the initial maps matrix can be retrieved from the random access memory 205 as the matrix operand stored in the maps banks 251 to 253 of a matrix-matrix unit 221. Alternatively, the DLA instructions 305 also include instructions for the Deep Learning Accelerator 203 to generate the initial maps matrix from the input 321.

According to the DLA instructions 305, the Deep Learning Accelerator 203 loads matrix operands into the kernel buffers 231 to 233 and maps banks 251 to 253 of its matrix-matrix unit 221. The matrix-matrix unit 221 performs the matrix computation on the matrix operands. For example, the DLA instructions 305 break down matrix computations of the trained Artificial Neural Network 301 according to the computation granularity of the Deep Learning Accelerator 203 (e.g., the sizes/dimensions of matrices that loaded as matrix operands in the matrix-matrix unit 221) and applies the input feature maps to the kernel of a layer of artificial neurons to generate output as the input for the next layer of artificial neurons.

Upon completion of the computation of the trained Artificial Neural Network 301 performed according to the instructions 305, the Deep Learning Accelerator 203 stores the output 313 of the Artificial Neural Network 301 at a pre-defined location in the random access memory 205, or at a location specified in an indication provided in the random access memory 205 to trigger the computation.

When the technique of FIG. 8 is implemented in the integrated circuit device 201 of FIG. 4, an external device connected to the memory controller interface 207 can write the input 321 into the random access memory 205 and trigger the autonomous computation of applying the input 321 to the trained Artificial Neural Network 301 by the Deep Learning Accelerator 203. After a period of time, the output 313 is available in the random access memory 205; and the external device can read the output 313 via the memory controller interface 207 of the integrated circuit device 201.

For example, a predefined location in the random access memory 205 can be configured to store an indication to trigger the autonomous execution of the instructions 305 by the Deep Learning Accelerator 203. The indication can optionally include a location of the input 321 within the random access memory 205. Thus, during the autonomous execution of the instructions 305 to process the input 321, the external device can retrieve the output generated during a previous run of the instructions 305, and/or store another set of input for the next run of the instructions 305.

Optionally, a further predefined location in the random access memory 205 can be configured to store an indication of the progress status of the current run of the instructions 305. Further, the indication can include a prediction of the completion time of the current run of the instructions 305 (e.g., estimated based on a prior run of the instructions 305). Thus, the external device can check the completion status at a suitable time window to retrieve the output 313.

In some embodiments, the random access memory 205 is configured with sufficient capacity to store multiple sets of inputs (e.g., 321) and outputs (e.g., 313). Each set can be configured in a predetermined slot/area in the random access memory 205.

The Deep Learning Accelerator (DLA) 203 can execute the instructions 305 autonomously to generate the output 313 from the input 321 according to matrices 307 stored in the random access memory 205 without helps from a processor or device that is located outside of the integrated circuit device 201.

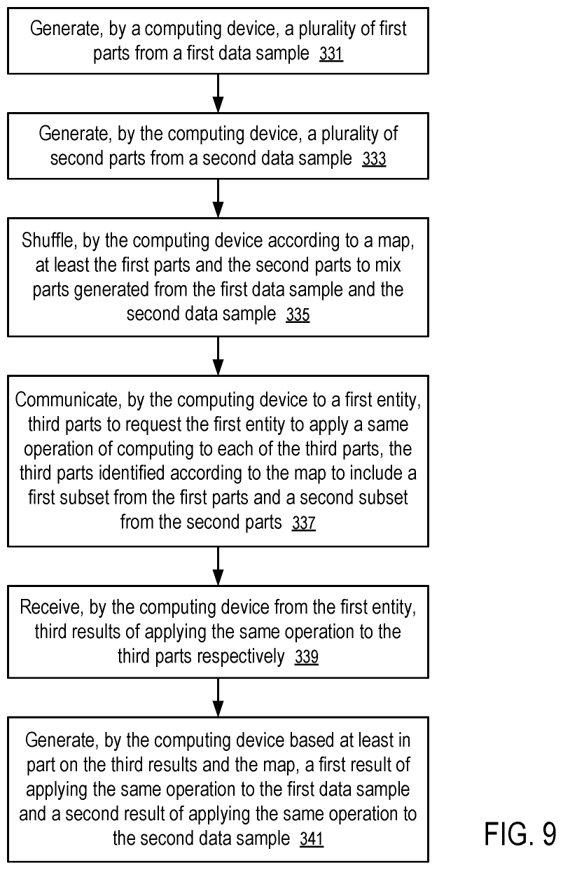

FIG. 9 shows a method of shuffled secure multiparty deep learning computation according to one embodiment.

For example, the method of FIG. 9 can be performed by a shuffled task manager implemented via software and/or hardware in a computing device to shuffle parts of data samples for outsourcing tasks of computing to other computing devices and to shuffle results of the computing applied to the parts back in order for the data samples to generate results of the same computing applied to the data samples, as in FIG. 1 to FIG. 3. The computing device can outsource the tasks to other computing devices having Deep Learning Accelerators (DLA) (e.g., 203 having processing units 211, such as matrix-matrix unit 221, matrix-vector unit 241, vector-vector unit 261, and/or multiply-accumulate (MAC) unit 271 as illustrated in FIG. 4 to FIG. 7). Optionally, the computing device can have a Deep Learning Accelerator (DLA) (e.g., 203) and a compiler 303 to convert a description of an artificial neural network (ANN) 301 to instructions 305 and matrices 307 representative of a task of Deep Learning Accelerator Computation 105. The task is generated such that an operation to sum 117 can be performed before or after the computation 105 without changing the result 157.

At block 331, a computing device having a shuffled task manager generates a plurality of first parts (e.g., 121, 123, . . . , 125; or 161, 163, . . . , 165) from a first data sample (e.g., 111; or 119).

For example, each of the first parts (e.g., 121, 123, . . . 125) can be based on random numbers; and the first parts (e.g., 121, 123, . . . , 125) are generated such that a sum 117 of the first parts (e.g., 121, 123, . . . , 125) is equal to the first data sample (e.g., 111).

For example, to generate the plurality of first parts (e.g., 121, 123, . . . , 125), the computing device can generate a set of random numbers as one part (e.g., 123) among the plurality of first parts (e.g., 121, 123, . . . , 125). Similarly, another part (e.g., 125) can be generated to include random numbers. To satisfy the relation that the sum 117 of the first parts (e.g., 121, 123, . . . , 125) is equal to the first data sample (e.g., 111), a part (e.g., 121) can be generated by subtracting from the data sample (e.g., 111) the sum 117 of the remaining parts (e.g., 123, . . . , 125).

For example, the first parts (e.g., 121, 123, . . . , 125) can be generated and provided at a same precision level as the first data sample (e.g., 111).

For example, each respective data item in the first data sample (e.g., 111) has a corresponding data item in each of the first parts (e.g., 121, 123, . . . , 125); and the respective data item and the corresponding data item are specified via a same number of bits.

At block 333, the computing device generates a plurality of second parts (e.g., 127, 129, . . . , 131) from a second data sample (e.g., 113). The second parts (e.g., 127, 129, . . . , 131) can be generated in a way similar to the generation of the first parts (e.g., 121, 123, . . . , 125)

At block 335, the computing device shuffles, according to a map 101, at least the first parts (e.g., 121, 123, . . . , 125) and the second parts (e.g., 127, 129, . . . , 131) to mix parts (e.g., 121, 135, . . . , 137, 129, . . . , 125) generated at least from the first data sample (e.g., 111) and the second data sample (e.g., 113) (and possibly other data samples (e.g., 115)).

At block 337, the computing device communicates, to a first entity, third parts (e.g., 137, 129, . . . , 125) to request the first entity to apply a same operation of computing 103 to each of the third parts (e.g., 121, 135, . . . ). The third parts (e.g., 137, 129, . . . , 125) are identified according to the map 101 to include at least a first subset from the first parts (e.g., 125) and a second subset from the second parts (e.g., 129).

For improved data privacy protection, the shuffled task manager in the computing device can be configured to exclude the first entity from receiving at least one of the first parts (e.g., 121) and/or at least one of the second parts (e.g., 127). For example, the computing device is configured communicate to the first entity some of parts from the first parts and the second parts but without communicating to the first entity at least one of the first parts and at least one of the second parts.

For example, the same operation of computing 103 can be representative of a computation (e.g., 105) in an artificial neural network 301 configured to be performed by one or more Deep Learning Accelerators (DLA) (e.g., 203) of external entities (e.g., the first entity). The Deep Learning Accelerators (DLA) (e.g., 203) can have matrix-matrix units (e.g., 221), matrix-vector units (e.g., 241), vector-vector units (e.g., 261), and/or multiply-accumulate (MAC) units (e.g., 271) to accelerate computations (e.g., 105) of an artificial neural network 301.

For example, the computing device can include a compiler 303 configured to generate, from a description of a first artificial neural network (e.g., 301), a description of a second artificial neural network represented by instructions 305 and matrices 307 to be executed in deep learning accelerators (DLA) (e.g., 203) to perform the deep learning accelerator computation 105 outsourced to external entities (e.g., the first entities). To outsource a task of performing the operation of computing 103 to the first entity, the computing device can provide the description of a second artificial neural network represented by (or representative of) instructions 305 and matrices 307 to the first entity. The computing device can provide the subset of first parts (e.g., 125) as the inputs (e.g., 321) to the second artificial neural network, and receive, from the first entity, the corresponding outputs (e.g., 313) generated by the Deep Learning Accelerator (DLA) (e.g., 203) of the first entity by running the instructions 305.

At block 339, the computing device receives, from the first entity, third results (e.g., 145, 147, . . . , 149) of applying the same operation of computing 103 to the third parts (e.g., 137, 129, . . . , 125) respectively.

At block 341, the computing device generates, based at least in part on the third results (e.g., 145, 147, . . . , 149) and the map 101, a first result 151 of applying the same operation of computing 103 to the first data sample (e.g., 111) and a second result (e.g., 153) of applying the same operation of computing 103 to the second data sample (e.g., 113).

For example, the computing device identifies, according to the map 101, fourth results (e.g., 141, . . . , 149) of applying the same operation of the computing 103 to the first parts (e.g., 121, 123, . . . , 125) respectively. The computing device sums (e.g., 117) the fourth results (e.g., 141, . . . , 149) to obtain the first result (e.g., 151) of applying the operation of computing 103 to the first data sample (e.g., 111).

For example, the computing device communicates, to a second entity, the at least one of the first parts (e.g., 121) (which is not communicated to the first entity) and requests the second entity to apply the same operation of computing 103 to each of the at least one of the first parts (e.g., 121). After receiving, from the second entity, respective at least one result (e.g., 141) of applying the same operation of computing 103 to the at least one of the first parts (e.g., 121), the computing device can determine, based on the map 101, that the least one result (e.g., 141) is for the at least one of the first parts (e.g., 121) and thus is to be summed 117 with other results (e.g., 149) of applying the operation of computing 103 to other parts generated from the first data sample to compute the first result (e.g., 151) of applying the operation of computing 103 to the first data sample (e.g., 111).

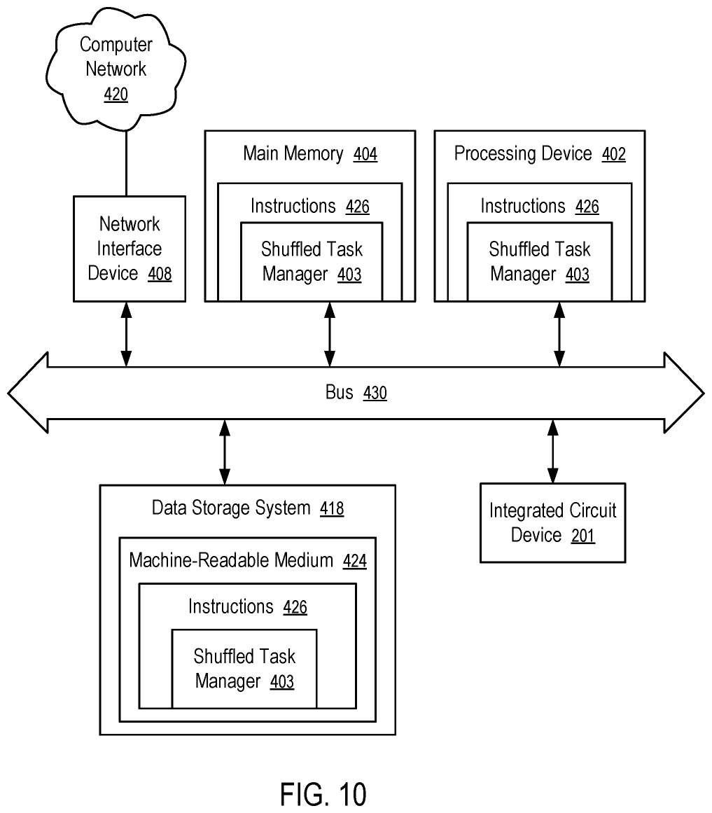

FIG. 10 illustrates an example machine of a computer system within which a set of instructions, for causing the machine to perform any one or more of the methodologies discussed herein, can be executed.

In some embodiments, the computer system of FIG. 10 can implement a shuffled task manager with operations of FIG. 9. The shuffled task manager can optionally include a compiler 303 of FIG. 8 with an integrated circuit device 201 of FIG. 4 having matrix processing units illustrated in FIGS. 5-7.

The computer system of FIG. 10 can be used to perform the operations of a shuffled task manager 403 described with reference to FIGS. 1-9 by executing instructions configured to perform the operations corresponding to the shuffled task manager 403.

In some embodiments, the machine can be connected (e.g., networked) to other machines in a Local Area Network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

For example, the machine can be configured as a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system illustrated in FIG. 10 includes a processing device 402, a main memory 404, and a data storage system 418, which communicate with each other via a bus 430. For example, the processing device 402 can include one or more microprocessors; the main memory can include read-only memory (ROM), flash memory, dynamic random access memory (DRAM), such as synchronous DRAM (SDRAM) or Rambus DRAM (RDRAM), static random access memory (SRAM), etc. The bus 430 can include, or be replaced with, multiple buses.

The processing device 402 in FIG. 10 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 402 can also be one or more special-purpose processing devices such as an application specific integrated circuit (ASIC), a field programmable gate array (FPGA), a digital signal processor (DSP), a network processor, or the like. The processing device 402 is configured to execute instructions 426 for performing the operations discussed in connection with the DLA compiler 303. Optionally, the processing device 402 can include a Deep Learning Accelerator 203.

The computer system of FIG. 10 can further include a network interface device 408 to communicate over a computer network 420.

Optionally, the bus 430 is connected to an integrated circuit device 201 that has a Deep Learning Accelerator 203 and Random Access Memory 205 illustrated in FIG. 4. The compiler 303 can write its compiler output (e.g., instructions 305 and matrices 307) into the Random Access Memory 205 of the integrated circuit device 201 to enable the Integrated Circuit Device 201 to perform matrix computations of an Artificial Neural Network 301 specified by the ANN description. Optionally, the compiler output (e.g., instructions 305 and matrices 307) can be stored into the Random Access Memory 205 of one or more other integrated circuit devices 201 through the network interface device 408 and the computer network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system, the main memory 404 and the processing device 402 also constituting machine-readable storage media.

In one embodiment, the instructions 426 include instructions to implement functionality corresponding to a shuffled task manager 403, such as the shuffled task manager 403 described with reference to FIG. 1 to FIG. 9. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

The present disclosure includes methods and apparatuses which perform the methods described above, including data processing systems which perform these methods, and computer readable media containing instructions which when executed on data processing systems cause the systems to perform these methods.

A typical data processing system may include an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-2394 bus adapter for controlling IEEE-2394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, Read Only Memory (ROM), Random Access Memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
generating, by a computing device, a plurality of first parts from a first data sample;
generating, by the computing device, a plurality of second parts from a second data sample;
shuffling, by the computing device according to a map, at least the first parts and the second parts to mix parts generated from the first data sample and the second data sample;
communicating, by the computing device to a first entity, third parts to request the first entity to apply a same operation of computing to each of the third parts, the third parts identified according to the map to include a first subset from the first parts and a second subset from the second parts;
receiving, by the computing device from the first entity, third results of applying the same operation to the third parts respectively; and
generating, by the computing device based at least in part on the third results and the map, a first result of applying the same operation to the first data sample and a second result of applying the same operation to the second data sample.

2. The method of claim 1, wherein the computing device is configured communicate to the first entity parts from the first parts and the second parts but without communicating to the first entity at least one of the first parts and at least one of the second parts.

3. The method of claim 2, wherein each of the first parts is based on random numbers; and a sum of the first parts is equal to the first data sample.

4. The method of claim 3, wherein the generating of the plurality of first parts includes generating a set of random numbers as one of the plurality of first parts.

5. The method of claim 3, wherein the generating of the first result includes:
identifying, by the computing device according to the map, fourth results of applying the same operation to the first parts respectively; and
summing, by the computing device, the fourth results to obtain the first result.

6. The method of claim 5, further comprising:
communicating, by the computing device to a second entity, the at least one of the first parts to request the second entity to apply the same operation of computing to each of the at least one of the first parts; and
receiving, by the computing device from the second entity, respective at least one result of applying the same operation to the at least one of the first parts;
wherein the first result is generated based on the respective at least one result of applying the same operation to the at least one of the first parts.

7. The method of claim 6, wherein the first parts are provided at a same precision level as the first data sample.

8. The method of claim 6, wherein each respective data item in the first data sample has a corresponding data item in each of the first parts; and the respective data item and the corresponding data item are specified via a same number of bits.

9. The method of claim 6, wherein the same operation is representative of a computation in an artificial neural network.

10. The method of claim 9, wherein the same operation is configured to be performed via multiply-accumulate units.

11. The method of claim 10, further comprising:
generating, by the computing device from a description of a first artificial neural network, a description of a second artificial neural network describing the same operation to be performed using a deep learning accelerator of the first entity.

12. A computing device, comprising:
memory; and
at least one microprocessor coupled to the memory and configured via instructions to:
generate a plurality of first parts from a first data sample;
generate a plurality of second parts from a second data sample;
shuffle, according to a map, at least the first parts and the second parts to mix parts generated from the first data sample and the second data sample; and
communicate, to a first entity, third parts to request the first entity to apply a same operation of computing to each of the third parts, the third parts identified according to the map to include a first subset from the first parts and a second subset from the second parts.

13. The computing device of claim 12, wherein the at least one microprocessor is further configured via the instructions to:
receive, from the first entity, third results of applying the same operation to the third parts respectively; and
generate, based at least in part on the third results and the map, a first result of applying the same operation to the first data sample and a second result of applying the same operation to the second data sample.

14. The computing device of claim 13, wherein the first data sample is equal to a sum of the first parts; and the first result is generated from a sum of results of applying the same operation to the first parts respectively.

15. The computing device of claim 14, wherein the at least one microprocessor is further configured via the instructions to exclude communication of at least one of the first parts and at least one of the second parts to the first entity.

16. The computing device of claim 14, wherein the at least one microprocessor is further configured via the instructions to generate, for each respective data item in the first data sample, a corresponding data item in each of the first parts; and the respective data item and the corresponding data item are specified via a same number of bits.

17. A non-transitory computer storage medium storing instructions which, when executed in a computing device, cause the computing device to perform a method, comprising:
receiving, from a first entity, third results of applying a same operation to third parts respectively, wherein the first entity is provided with the third parts selected from a shuffled collection of first parts generated from a first data sample and second parts generated from a second data sample; and
generating, based at least in part on the third results and a map used to shuffle the first parts and the second parts, a first result of applying the same operation to the first data sample and a second result of applying the same operation to the second data sample.

18. The non-transitory computer storage medium of claim 17, wherein the method further comprises:
generating the first parts from the first data sample and random numbers;
generating the second parts from the second data sample and random numbers;
shuffling, according to the map, at least the first parts and the second parts to mix parts generated from the first data sample and the second data sample; and
communicating, to the first entity, the third parts to request the first entity to apply the same operation of computing to each of the third parts, the third parts identified according to the map to include a first subset from the first parts and a second subset from the second parts.

19. The non-transitory computer storage medium of claim 18, wherein the first data sample is equal to a sum of the first parts; and the first result is generated from a sum of results of applying the same operation to the first parts respectively.

20. The non-transitory computer storage medium of claim 19, wherein the method further comprises:
excluding at least one of the first parts and at least one of the second parts from being communicated to the first entity.
